(19) United States
(12) Patent Application Publication
(10) Pub. No.: US 2006/0231360 A1
(43) Pub. Date: Oct. 19, 2006

(54) Pneumatic shock absorber with an ancillary air chamber

(75) Inventor: Meng-Zong Chen, Taichung Hsien (TW)

Correspondence Address: John S. Egbert;Harrison & Egbert, 7th Floor, 412 Main Street, Houston, TX, 77002, US

(73) Assignee: A-PRO TECH CO., LTD., Taichung Hisen (TW)

(21) Appl. No.: 11/105,742

(22) Filed: Apr. 15, 2005

(51) Int. Cl. F16F 9/00

(52) U.S. Cl. 188/314; 267/64.15

(57) ABSTRACT

The present ilylltivllj provides-a pneumatic shock absorber fitted with an ancillary air chamber. The miajor fatuire of such know-how is that pneumatic shock absorber is fitted with an ancillary air chamber interconnected to or separated from air chamber of cylinder body. And, a floating piston is mounted into the ancillary air chamber. Based on this imiiovative design when When the extensible axle of pneumatic shock absorber starts to shrink, the effective flexible travel can be extended in tune with the volume change of ancillary air chamber, thereby meeting actual demands of drivers.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a pneumatic shock absorber, and more particularly to a pneumatic shock absorber which is designed with an ancillary air chamber linked to the cylinder body's air chamber.

### BACKGROUND OF THE INVENTION

Generally, the conventional pneumatic shock absorber is characterized by compressible high-pressure gas instead of conventional spring members, thereby offering the same flexibility for its extensible axle under stress. Yet, no continued compression could be performed when gas is compressed in a single enclosure to some extent, namely, a turning point will be visibly formed at rear section of the compression curve, from which the travel requires a sharp escalating compressive force. Therefore, conventional pneumatic shock absorber cannot meet the actual demands owing to a very limited range of effective travel. Also, flexible shock resistance will be very poor because of excessive resilience force of compressed gas, leading to degraded performance of shock absorber.

Thus, to overcome the aforementioned problems of the prior art, it would be an advancement in the art to provide an improved pneumatic shock absorber of desirable performance.

To this end, the inventor has provided the present invention of practicability after deliberate design and evaluation based on his years of experience in the production, development and design of related products.

### BRIEF SUMMARY OF THE INVENTION

Based on this innovative design of present invention, when extensible axle of pneumatic shock absorber starts to shrink, the effective flexible travel can be extended in tune with the volume change of ancillary air chamber. The comparative schematic drawing between pressure curve LI of shock absorber's cylinder air chamber and typical pressure curve L2 is shown in FIG. 6. It can be learnt from this figure that, the effective travel of extensible axle of present invention can be practically extended (shift backwards from al to a2), thereby meeting actual demands of drivers.

Also, based on the design that a control valve is mounted onto external air chamber ofthe first ancillary air chamber, air pressure of the air chamber can be adjusted so as to control the pressure of shock absorber under an extension state.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exterior perspective view of preferred embodiment of the present invention.

FIG. 2 shows a cutaway view of the internal structure of the preferred embodiment of the present invention.

FIG. 3 shows an operating view of the preferred embodiment of the present invention.

FIG. 4 shows a diagram of the first ancillary air chamber fitted with a spring.

FIG. 5 shows a cutaway view of the internal structure of another preferred embodiment of the present invention.

FIG. 6 shows the pressure curve comparison chart of the present invention and conventional pneumatic shock absorber.

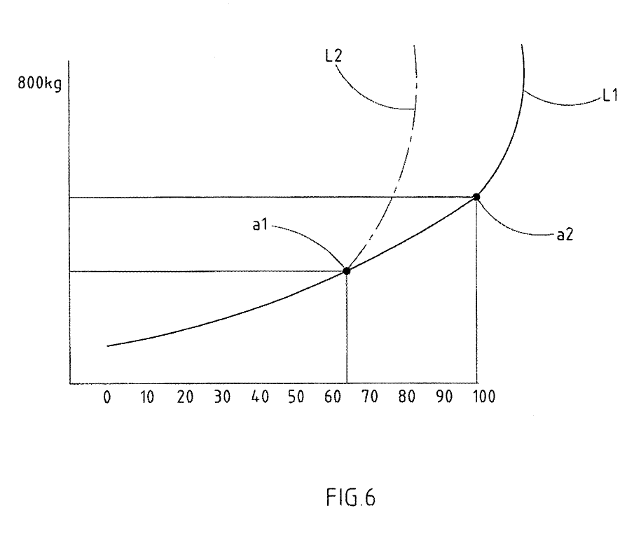

### DETAILED DESCRIPTION OF THE INVENTION

The features and the advantages ofthe present invention will be more readily understood upon a thoughtful deliberation of the following detailed description of a preferred embodiment of the present invention with reference to the accompanying drawings.

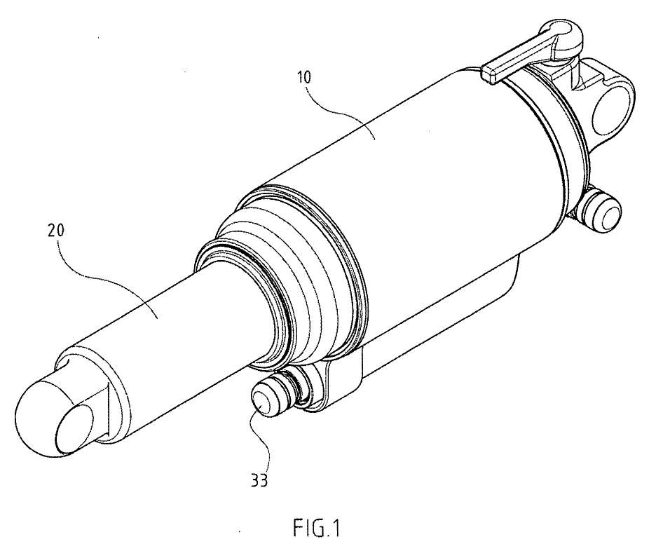

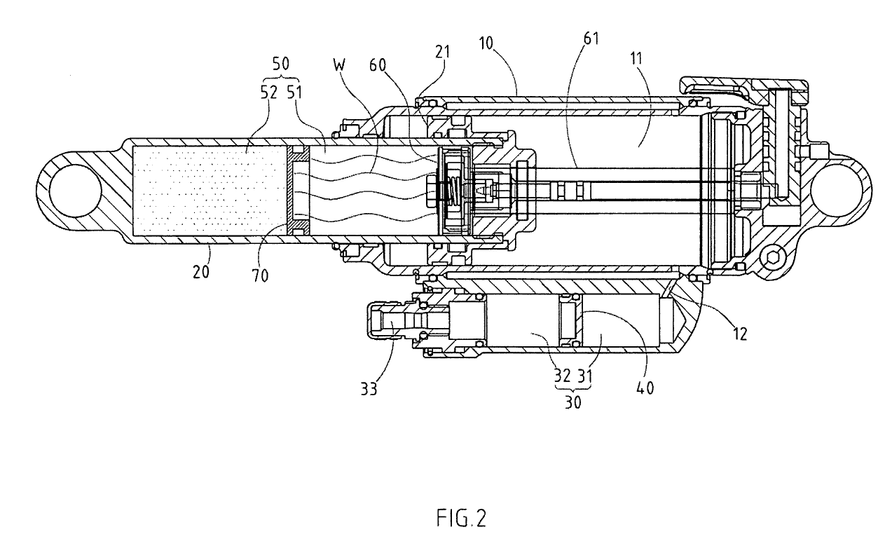

As shown in FIGS. 1-3, a pneumatic shock absorber with an ancillary air chamber embodied in the present invention comprises:
a cylinder body 10, with a hollow air chamber 1 1;
an extensible axle 20, which can slide by combining a piston 21 with air chamber 11 of cylinder body 10;
at least a first ancillary air chamber 30, which is installed at one side of cylinder body 10, but separated from its air chamber 11 and interconnected via a gas vent 12;
a first floating piston 40 mounted into first ancillary air chamber 30, which is used to divide first ancillary air chamber 30 into an internal air chamber 31 and an external air chamber 32;
at least a second ancillary air chamber 50, which is installed within extensible axle 20, and separated from air chamber 11 of cylinder body via a secondary piston 60. This secondary piston 60 is located at a fixation point of cylinder body 10 far away from extensible axle 20 via the help of a member bar 61; and
There is a second floating piston 70 mounted into second ancillary air chamber 50, which is used to divide second ancillary air chamber 50 into an internal groove 51 and an external groove 52.

Based on aforementioned composition and design, the shock absorber can function as detailed below:

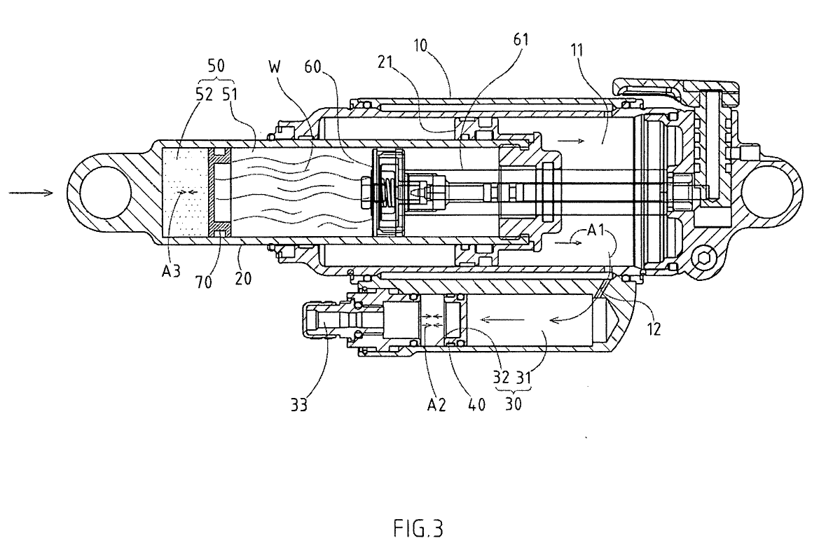

As shown in FIG. 3, when extensible axle 20 starts to shrink, air Al within air chamber 11 of cylinder body 10 will be compressed towards first ancillary air chamber 30 via a gas vent 12, and then drive first floating piston 40 to slide outwards and compress air A2 within external air chamber 32. At the same time, second ancillary air chamber 50 within extensible axle 20 is compressed reversely by secondary piston 60 such that it can drive second floating piston 70 to slide outwards and then compress air A3 within external groove 52 of second ancillary air chamber 50.

Of which, a control valve 33 is placed at exterior of external air chamber 32 of the first ancillary air chamber 30, thereby adjusting the elasticity of compression according to the strength of input air pressure.

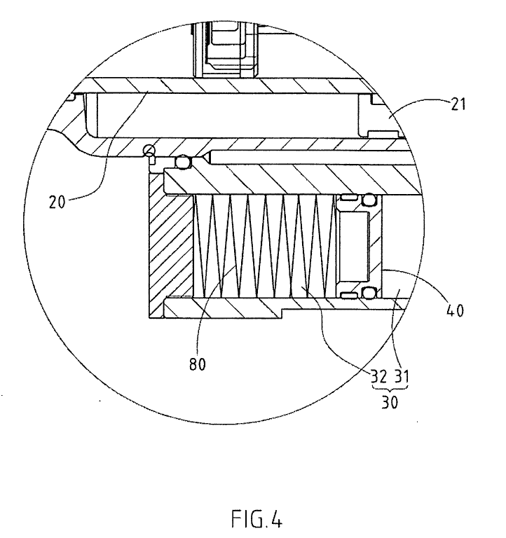

And, as shown in FIG. 4, external air chamber 32 of first ancillary air chamber 30 is fitted with a spring 80, such that first floating piston 40 can be flexibly supported thanks to the accumulated elastic force of spring.

Also, internal groove 51 of second ancillary air chamber 50 can be designed in such a way to accommodate oil fluid W.

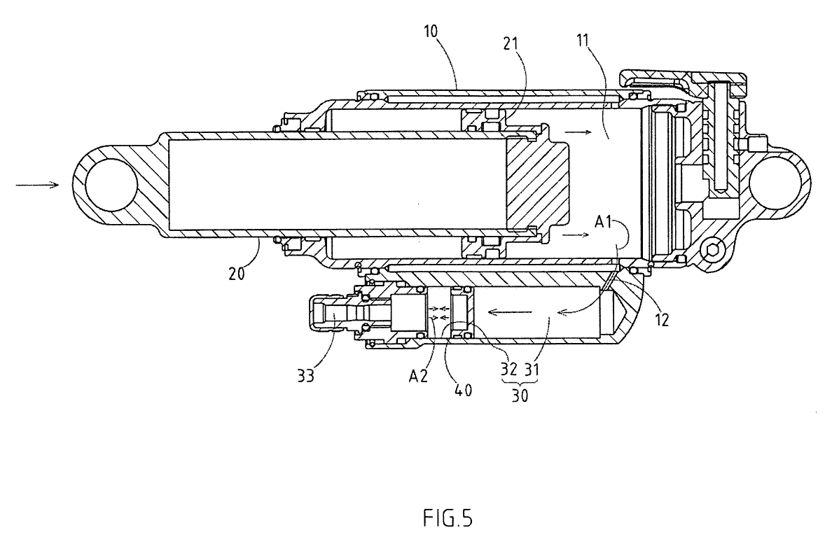

FIG. 5 shows another preferred embodiment of the present invention of pneumatic shock absorber fitted with an ancillary air chamber. Its difference with the former one is that extensible axle 20's second ancillary air chamber 50, secondary piston 60, member bar 61 and second floating piston 70 can be saved accordingly, whilst only first ancillary air chamber 30 is maintained to serve the same purpose of extending effective travel of extensible axle.

1. A pneumatic shock absorber with an ancillary air chamber comprising:
a cylinder body, with a hollow air chamber;
an extensible axle, wilihcliC sl being slidable by combining a piston with air chamber within said cylinder body;
at least a first ancillary air chamber, which is installed at one side of cylinder body, but separated from its an air chamber thereof and interconnected via a gas vent;
a first floating piston mounted into first ancillary air chamber, wlicl is used to divide dividing the first ancillary air chamber into an internal and external air chamber;
at least a second ancillary air chamber, whiicih is installed within extensible axle, and separated from the air chamber of the cylinder body via a secondary piston.This said secondary piston is being located onto a cylinder body via thle felp of a member bar; and
a second floating piston mounted into second ancillary air chamber, whliclh is being used to divide second ancillary air chamber into an internal and external groove.

2. The pneumatic shock absorber with an ancillary air chamber defined in claim 1, wherein air within the air chamber of the cylinder body will be is compressed towards first ancillary air chamber via a gas vent, and then de a first floating piston being driven to slide outwards and compress air within external air chamber when said extensible axle starts to shrink-. At thle- and at a same time, second ancillary air chamber within extensible axle is compressed reversely by secondary piston such that it can drive the second floating piston is driven to slide outwards and compress air within external groove of second ancillary air chamber.

3. The pneumatic shock absorber with an ancillary air chamber defined in claim 1, wierein further comprising: a control valve is placed at an exterior of external air chamber of said first ancillary air chamber.

4. The pneumatic shock absorber with an ancillary air chamber defined in claim 1, wherein sad the external air chamber of said first ancillary air chamber is also fitted with a spring.

5. The pneumatic shock absorber with an ancillary air chamber defined in claim 1, wherein an internal groove of said second ancillary air chamber accommodates oil fluid.

6. A pneumatic shock absorber with an ancillary air chamber comprising:
a cylinder body, with a hollow air chamber; and
an extensible axle, being slidable by combining a piston with an air chamber within said cylinder body; and
at least a first ancillary air chamber, installed at one side of cylinder body, but separated from its an air chamber thereof and interconnected via a gas vent; and
a floating piston mounted into ancillary air chamber, which is being used to divide the ancillary air chamber into an internal and external air chamber.

7. The pneumatic shock absorber with an ancillary air chamber defined in claim 6, wherein air within air chamber of cylinder body will be cotnpressed compresses towards the ancillary air chamber via a gas vent, and then drive drives the floating piston to slide outwards and compress air within external air chamber when said extensible axle starts to shrink.

8. The pneumatic shock absorber with an ancillary air chamber defined in claim 6, further comprising:
a control valve is placed at an exterior of the external air chamber of said ancillary air chamber.

9. The pneumatic shock absorber with an ancillary air chamber defined in claim 6, wherein the external air chamber of said ancillary air chamber fitted with a spring.
